(19) United States
(12) Patent Application Publication
(10) Pub. No.: US 2016/0343195 A1
(43) Pub. Date: Nov. 24, 2016

(54) MULTIPLE-USER INFORMATION SOURCING SYSTEMS & METHODS IN A GAMING ENVIRONMENT

(71) Applicant: J & C Technology, LLC, Lake Oswego, OR (US)

(72) Inventors: Curtis James Goodwin, Lafayette, OR (US); Jeffrey David Lee, Keizer, OR (US)

(21) Appl. No.: 14/717,897

(22) Filed: May 20, 2015

(51) Int. Cl. G07F 17/32; A63F 13/23

(52) U.S. Cl. CPC G07F 17/3204; G07F 17/3286; G07F 17/3272; A63F 13/23

(57) ABSTRACT

Systems and methods for multiple-user information sourcing in a gaming environment. In some example, the information sourcing is analyzed and correlated with one or more players. The gaming environments are any games, such as craps and poker. The gaming environment information can be shared with any one or more of the players.

### BACKGROUND

Gaming is entertaining for many people all over the world and is a deeply-ingrained part of society. Some people enjoy casual trips to gaming destinations, such as Las Vegas and Macau, and others visit gaming establishments and/or travel to gaming destinations on a regular basis. The gaming experience is a social community for many players. Players enjoy gaming with players they like, players they already know, players with similar interests or something in common, or other attractive qualities. Some games, like craps and poker, generate a social or community feel. These games tend to be more fun for players when the social environment is fun. Additionally, in some of the more social games, one player may be the focus of the game while others place bets on the player's activities. If the one player at the focus of the game is doing well, it typically creates a fun gaming environment for the other players and might attract even more players and/or observers to join in the fun.

For example, craps is a social game in which one player rolls the dice and other players place bets on the dice rolls. Craps is also a somewhat unique game in which the player rolling and every player betting on the roller's rolls are collectively adverse to the gaming establishment. In a sense, the player rolling the dice and the other players are on the same “team” since their individual success is based entirely on the actions of the player rolling the dice so they all have a common and unified interest. Craps positions the team of players against the gaming establishment. Typically in other games, the players are individually, rather than collectively, adverse to the gaming establishment. Everyone, including the individual players to the gaming establishment, benefits when a craps gaming environment is fun and attracts players. The players benefit from having a fun experience and the gaming establishment benefits from making money from player bets and purchases.

Because craps is unique in being a game of all players have a common goal of having the player rolling the dice roll well, the social environment of the game while it is being played is very important to the players. When the social environment of a craps game is fun, it attracts players to it and is considered a “hot” table. A hot table usually generates positive attention from both the players already betting on the player rolling the dice and other players who want to join the hot game or observe the game because it seems fun. The gaming environment of a hot craps table becomes even more fun and attractive when the person rolling and/or the people playing the game are having fun themselves. Conversely, many craps tables are cold meaning that they do not have a fun gaming environment for any number of reasons or have some aspect of the game that is not favorable or attractive to the players. In a craps game, a table could be considered cold if the player rolling the dice is not rolling well, if the available positions at the game table are not filled, or for any other reason.

These gaming environments generally, and more specifically craps games, are fun for those players who are either already playing the game at the table or anyone that happens to walk by the table. Occasionally, a player or observer of a game might send a message, like a text message, e-mail, or phone call, to a friend or someone else who is not located at the game table to let that person know that the game table is hot or cold. Such messages might be delayed for any number of reasons and may provide only limited or incomplete information about a single game table.

Players of games, and especially a community game like craps, tend to spend a lot of time searching for a hot table when they go to a gaming destination or any other location with multiple game tables. For example, a craps game with a player who is not rolling well or with players that are not creating a fun gaming environment is not attractive to other players. Those other players are not likely to join such a cold table. Players would much prefer to be playing the games rather than searching for an attractive table.

Therefore, there is a need in the art of gaming for systems and methods that help maximize players' enjoyment of a game in an efficient, cost-effective, informative, and community-based manner.

### SUMMARY

Aspects of the disclosure include various systems and methods for multiple-user information sourcing in a gaming environment. A disclosed multiple-user information sourcing system can include a server, a processor, and an output. The server is configured to receive observer information and to receive player information. The observer information and the player information can, in some examples, come from an observer device and a player device, respectively, although it can come from other sources. The observer information can include one or more characteristics from a gaming environment. The player information can include one or more characteristics about a player.

The processor in the example system processor can be configured to analyze the observer information to determine if one or more of the observer characteristics includes information that indicates whether a game being played in the gaming environment has a first status or a second status of a game being played in the gaming environment. The processor can also be configured to generate a game profile for the game based on the characteristics about the game and to analyze the player information to determine if the game characteristics correlate with any aspect(s) of the game profile. Further, the processor is configured to generate a matched player-game option associated with the player if one or more of the player characteristics correlate with any aspect(s) of the game profile. In some examples, the system can include an output that is configured to output any matched player-game option(s) along with any player information and gaming environment information. The output can be a display or other sensory output.

In some examples, the disclosed systems can receive a request from a remote computing device for some portion of the game profile and/or the player profile. In response to the received request, the system may send a portion of the game profile and/or the player profile to the remote computing device. The systems and methods described here can be implemented in any gaming environment. In some examples, the disclosed systems and methods operate in a craps gaming environment although they could be implemented in any other gaming environment.

In another aspect of the disclosure, a method of multiple-user information sourcing can include receiving information about both a first game and a second game from one or more game-observing sources. The method can receive information about any additional number of games. The received information about the first game and the second game, or more games in the other embodiments, is stored in a game database. The stored information about the first game and the second game is analyzed. The method further generates a first game profile based on the stored information about the first game and a second game profile based on the stored information about the second game. In some embodiments, a portion or all of the first game profile and the second game profile are displayed on display. The display is optional be located in the gaming environment or remote from the gaming environment.

Any of the above generated and/or received information about the players and/or the game(s) can be displayed on a display of any kind, including an end user device. Software or other computer-readable media can operate on the end user device, such as an application for a mobile device, tablet, television, or other computing device. The end user of the application can access the information about the games and/or the players at any location on the end user device running the application. The application can communicate inquiries and receive responses from a backend server and/or processor that receives and processes the information about the game(s) and the players.

### BRIEF DESCRIPTION OF THE DRAWINGS

FIG. 1 is an example diagram of a multiple-user information sourcing gaming system, according to aspects of the disclosure.

FIG. 2 shows an example flowchart of a multiple-user information sourcing gaming process, in accordance with aspects of the disclosure.

FIGS. 3-10 are screenshots of an example application for the disclosed multiple-user information sourcing gaming systems and processes, in accordance with aspects of the disclosure.

### DETAILED DESCRIPTION

Games are played in various gaming environments all over the world. Some are small gaming establishments and others are in a network of gaming establishments like those that exist in Las Vegas. The disclosed methods and systems provide a fun, engaging, informative, community-based service to users that gives the users current, on-demand information about many gaming environments.

Two main user roles exist within the disclosed systems and methods. First, the observer who observes the gaming environment. Second, the player who is interested in seeing information about the gaming environment and generally interacting with the system. The observer can also be the player. A person could be either an observer or a player. Generally, the system is a multiple-user or “crowd” sourcing technique of gathering information about various ongoing, live events—the games—and compiling and analyzing the gaming environment information for communication to a user. In some examples, the information is customized to a player. In other examples, a portion of the information is pushed to all players while another portion of the information is reserved for restricted access by a select group of players based on the player information. Players and observers can both contribute to and pull data from the disclosed systems and methods, in either a generic or a customized form.

When a player profile is activated, the system, through the processor could automatically push selected information to the player profile. For example, a player logs on to the associated player profile through a user interface in the form of an application stored on the player's computing device. Once the log in process is complete, the application is programmed to transmit a data message to the system that notifies the system that the player profile is active. The system can respond to the activation message by sending gaming environment information or other data that might be useful or interesting to the player.

The disclosed systems and methods can be implemented in any gaming environment including games at gaming establishments like craps and poker and other gaming environments like race tracks or boxing matches. Many of the examples discussed here are in the context of a craps game, although one of skill in the art will understand that the same systems and methods can be applied to any other gaming environment.

I. Multiple-User Information Sourcing Gaming Systems

The disclosed systems and methods provide a system of sourcing information about one or more games from multiple sources, compiling and analyzing the sourced information, and presenting it in various ways to end users. They also provide users with current, comprehensive information about one or more game tables and offer a community environment for learning about the gaming information. The information about the game tables is gathered from multiple sources, which creates a gaming community.

The compiled, analyzed information along with other content is shared with remote users within the community. Many of the remote users might access the gathered information and any other content through creating a player profile in an application. The application, or other software, can run on various end user devices like mobile phones, smart devices tablets, computers, televisions, and the like. The application is a user interface for players to access the community information stored in the system.

In some examples, the disclosed systems can include a server, a processor, observer input device(s), and user output device(s). The system has multiple users that source the information about a gaming environment of one or more gaming tables. The system can also receive information at the server about an observer, a player, and/or a remote user. The observer, player, and/or remote user can be the same person in some circumstances. In other examples, the observer is also playing the game so the observer and the player are the same person. In still other examples, the observer, the player, and the remote user are each different people.

The observer generally observes a game table and collects information about the status or other features of the game, the gaming environment, the number of player positions that are available and/or open at the game table, the other players who are present at the game table, and any other gaming environment information. The observer can also observe and collect information nearby the gaming environment, such as whether an event is scheduled near the gaming table, like a concert, a celebrity siting, the popularity of a particular restaurant or nightclub nearby or in the gaming establishment, and the like. The observer information can include information about events that are in close geographic proximity to the game environment(s) or they can include information about events remote from the gaming environment. In some examples, the players could include a setting in the player profiles that sets or defines the geographic proximity within which the player would like to see events. The player could choose to see no events, alternatively.

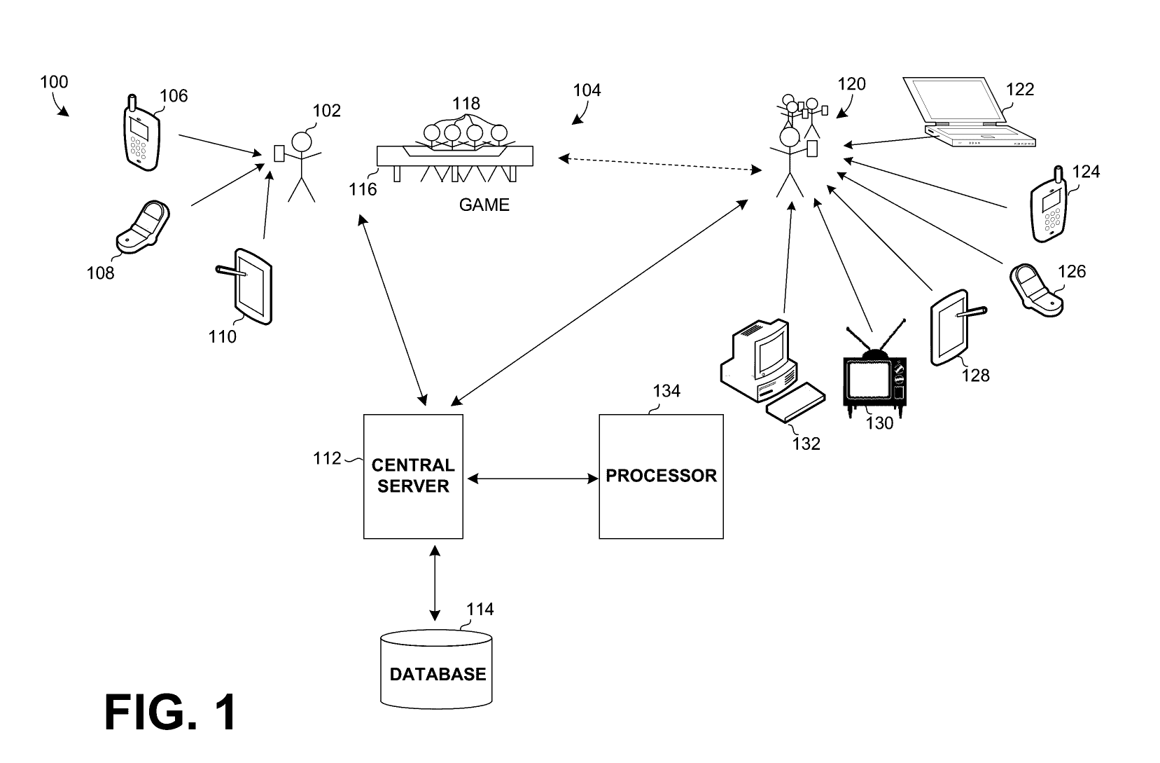

FIG. 1 shows a multiple-user information sourcing system 100 that has an observer 102 that is physically positioned near a gaming environment 104 that has a game table. FIG. 1 shows the observer as a single person, but any number of observers can be included. The observers each have an observer device of some kind, like the smart phone 106, the mobile phone 108, and the tablet 110 shown in FIG. 1. The observer 102 observes characteristics about the gaming environment 104 and enters those observed characteristics into the observer device. The observer device transmits the observed characteristics to a central server 112 that has a processor 114. The central server 112 has a database that stores information about the observer characteristics.

When the central server 112 receives information from an observer device about a gaming environment, the central server 112 queries the database 114 to determine whether a profile exists for the gaming environment. If no profile exists, a new gaming environment profile is created and the gaming characteristics are stored in the new gaming environment profile. If a gaming environment profile is already stored in the database 112, the additional gaming characteristics are stored within the existing gaming environment profile.

The gaming environment 104 shown in FIG. 1 has a game table 116 with multiple players 118. The observer 102 observes the players 118 playing the game at the game table 116 among other things in the gaming environment. As discussed above, the observer 102 could also be one of the players 118 actively playing the game at the game table 116 or the observer 102 could be someone simply observing the game being played by others.

The observer 102 compiles gaming characteristics about the gaming environment 104. The gaming characteristics can include information about the game itself. For example, some games might be associated with a particular status. The games could be assigned any number of different available statuses. For example, a craps game could be considered “hot” or “cold.” Some objective and some subjective factors determine whether an observer would consider a particular craps table hot or cold.

Generally, observers familiar with the game of craps generally have a sense for when the table is hot or cold based on a variety of factors. Some of the objective factors might include the number of successful rolls by the player rolling the dice in the craps game, the number of available positions open for new players to join the game, and the number of people watching the game. Some of the subjective factors might include whether the players and any people watching are friendly and seem to be having fun, whether the players and any people watching are talking and laughing with each other, and the like.

The gaming environment characteristics observed by the observer and transmitted to the server can also include information about the gaming establishment at which the gaming environment 104 is located, nearby restaurants or nightclubs, events scheduled nearby, celebrity sitings, and the likes. The gaming environment characteristics could even include information about the local weather and nearby hotel availability or restaurant reservations. Any suitable characteristics, subject and objective, can be included in the observer characteristics that are transmitted to the server 112.

One or more players 120 or end/remote users create a player profile by transmitting information about themselves to the central server 112. The players 120 input information about themselves through a player or end user device such as the laptop 122, smart device 124, cellular phone 126, tablet 128, television 130, and computer 132 shown in FIG. 1. The players 120 input information about themselves that is transmitted to and received by the central server 112.

When the central server 112 receives information about a player, the central server 112 queries the database 114 to determine if the player has an existing player profile. If a player profile does not exist for the player information, then the central server 112 creates a new player profile and stores the player information in the new player profile. If the central server 112 finds an existing player profile associated with the player information, the player information is added to and stored in the player profile on the database 114. The database 114 shown in FIG. 1 stores both the gaming environment profiles of various gaming environments and the players. In alternative examples, the gaming environment profiles are stored separately from the player profiles.

The disclosed system in FIG. 1 also has a processor 134. The processor 134 is shown as a separate computing module from the central server 112 in FIG. 1, but oftentimes the processor 134 is physically located in the same computing device as the central server 112 although the central server 112 and the processor 134 can be electrically coupled in any suitable computing environment. Likewise, the database 114 is shown as a separate computing module from the central server 112 and the processor 134 and can be physically located in the same computing device as the central server 112 and/or the processor 134.

The processor 134 is configured to analyze information that the observer 102 transmits to the central server 112. The information sent by the observer 102 can include information about the gaming environment. In a specific example of a craps game, the observer 102 can send characteristics that include information about whether the craps game is hot or cold. The processor 134 analyzes the sent observer information to determine if the information indicates whether the craps game is hot or cold, for example. The craps game profile is updated on whether the newest information about the craps game status, such as whether the game is hot or cold, based on the

The information sent by the observer could include a single status of the observed games in other example embodiments. For example, the observer could only send information about a hot craps table and does not send information about any cold craps tables. The observed information about the craps games that is transmitted to the central server 112 could change depending on the entity providing the service to players. For example, if a gaming establishment were to offer a service to its guests so the guests can locate where a hot craps table was located within the gaming establishment, the gaming establishment might not include identifying a particular table as cold to avoid any undue negative attention being directed to the cold table. Further, the gaming establishment could send player specific information, such as incentives to play at a particular table, especially one that is determined to be cold.

Alternatively, if the service is provided by an independent entity, the independent entity can include different gaming environment information in the gaming environment profile than would a gaming establishment itself. For example, in addition to information about the games themselves, the independent service can include in its gaming environment profiles information about ratings of various gaming establishments, wait staff and other provided services, ambiance, food and drink quality, and the like. Further, the independent services could include gaming environment profiles for multiple gaming establishments in any location. Some services might choose to focus on a particular city, like Las Vegas, while others might include gaming environment profiles for gaming environment located in multiple different cities.

The processor 134 shown in FIG. 1 also analyzes the player information to determine if the player characteristic(s) correlate with any aspect of the craps game profile. As discussed above, the player information could be stored in a player profile. Alternatively, the player information could simply be transmitted to the central server, the processor could perform its analysis and provide its output on the correlation between with the player characteristics and the craps game profile and then delete the player information. If any aspect of the player information correlate with any aspect of the craps game profile, the processor 134 generates a matched player-craps game option that is then associated with the player or player profile, if the player has a profile.

For example, the correlation between the craps game profile and the player information/player profile can be any predetermined potential connection. For example, the processor might determine that the player input a player characteristics that includes multiple preferences for the player's desired gaming environment, such as for a particular favorite gaming establishment, the player's preferred time of day to play the game, the player's favorite band is scheduled to play at the gaming establishment, and the like. An example correlation between the player information/profile and the craps game profile happens when a craps table is determined to be hot at a gaming establishment that is a favorite of the player or at which the player's favorite band is scheduled to play a concert the same evening.

The processor makes the correlation between the player information/profile and the gaming environment profile and then generates a matched player-craps game option that is associated with the player. The matched player-craps game option is communicated to the player. In some examples, the matched player-craps game option is transmitted from the central server 112 or processor 134 to the player 120 and appears on the display of the player's device.

The processor 134 can perform analysis to determine correlations between the player information/player profile and any suitable number of gaming environment profiles. The processor 134 can either actively send correlations in the form of the matched player-craps game option to the player device or the player could send a request for information about one or more gaming environments to the central server 112. The central server 112 could also send push notifications to the observers 102 and/or the players 120. The push notifications could include any information relevant or desired to reach the observer and/or the player. The push notifications could potentially include advertisements, incentives, offers, notifications of events, requests for feedback on a gaming establishment or elsewhere, invitations to private events or private gaming opportunities, and the like.

The players 120 can access the player profile, if they have one, and the gaming environment profile from anywhere. Oftentimes, the players are remote from the gaming environments of interest. The central server 112 can permit the players, in some examples, to select one or more gaming establishments or a geographic region within which various gaming environments are located. The player preference information can be stored in the player profile and information about the identified gaming establishments is sent to the player. The player can view the identified gaming establishment's information, from a remote location to the actual gaming environments themselves. Some players may wish to follow the activities or trends of the gaming environments. Other players may wish to do another activity until a craps table of interest is identified as hot and such information is either requested or actively sent in the form of a push notification to the player's device.

The players, for example, could enjoy an activity like eating dinner, enjoying a cocktail at a bar, or resting or socializing in their hotel room all of which are locations that are remote from the gaming environment. The player sees that a particular gaming environment of interest becomes hot and can choose to go to the gaming environment to play the game. The players can enjoy other activities while waiting for a nearby or desirable gaming environment to become attractive, such as a craps game going hot, and can increase their enjoyment of the game because they are more often playing games in a fun and desirable gaming environment.

The observer information is generally transmitted from the observer devices 106, 108, 110 to the central server 112 in live while the games are being played at the game table 116. The observer 102 attempts to provide current and real-time information to the central server 112 so the observed information is relevant to players 120. Essentially, the observer information received by the central server 112 can be a live or near live information about the game being played at the game table 116. In a game like craps and other games, the game environment might change frequently and quickly. Once the observer 102 transmits the gaming environment information to the central server 112, either the central server 112 pushes the gaming environment information to the players with a matched player-game option, such as any identified correlation between the gaming environment and the player information or player profile, or, in response to a request from a player device for information about a particular gaming environment, transmits to the requesting player device the gaming environment information.

As such, the central server 112 either pushes the notifications to the player devices based on some correlation identified between the gaming environment and the player information/profile or transmits the gaming environment information to the player on-demand and in response to a request.

For example, a player may wish to visit a particular gaming destination and creates a player profile for the player's group of favorite gaming establishments. The player can add to the player profile the dates on which the player plans to visit the gaming destination. The central server 112 actively pushes gaming environment information to the player's device during the dates on which the player is visiting the gaming destination. Before and/or after the player's visit to the gaming destination, the central server may not push the gaming environment information to the player's device and may offer to the player an option to request, on-demand, gaming environment information instead.

In this example, the player may access, on-demand the gaming environment information remotely from the gaming destination and before the player is nearby the gaming establishment, i.e., from the player's home geographic location. After the player arrives at the gaming destination, the player's interaction with the central server and the player's receipt of gaming environment information can continue to be in an on-demand configuration or can change to an active and automatic push notification configuration in which the player actively receives information from the central server about the correlated gaming environments without the need for the player to submit a request for the information.

Once the player 120 receives the gaming environment information at the player device of choice, the player 120 can choose to visit one of the gaming environments. Some players might wish to join active, “hot” games while other players might prefer a less active game to join. Player preferences about the games can be entered into the player profile. Players can interpret and use the gaming environment information and the correlations and matched player-game options in any suitable manner.

In some examples, multiple players create player profiles in the disclosed systems. The multiple players can communicate with each other through player-to-player message in the system and can share any information stored in the system with any other player profile. For example, players might communicate with each other to create a group of players that plan to visit a particular gaming destination together. All players in the group can message each other through the system to plan the trip, coordinate travel plans, and communicate with each other during their visit to the gaming destination, among other shared information. As with other social networks, groups of players with profiles on the disclosed systems can place privacy settings on a portion or all of the information on the player profile so that some portion of or all of the player profile is viewable by other players. Players may wish to create a network of joined players with whom they have some connection. To do so, players may send an invite to connect with other players. Once accepted, the connections can share gaming environment information, feedback, messaging, incentives, etc.

The disclosed systems and methods also provide one or more ratings of various aspects within the system. The ratings can include feedback, reviews, and scores on any aspect within the system, including the accuracy of an observer to provide usable gaming environment information, the clarity and completeness of the information provided by the observer, the quality and overall experience of the gaming establishments, the successes of other players, and the like. Any ratings information can be included.

For example, observers are encouraged to transmit accurate, current, and complete information about the gaming environment to the central server 112 for analysis and sharing, as needed, with one or more player(s). A credible observer source for the gaming environment information increases the player's likelihood of receiving information that increases the player's enjoyment of the games by allowing the player to find attractive games quickly and efficiently. A player that goes to a game table or gaming environment based on an observer's gaming environment information is able to judge the accuracy, helpfulness, completeness, and overall usefulness of the information submitted to the observer. That player is then able to determine a rating for the gaming environment information through the player device, which is received at the central server and is associated with an observer. The player-submitted ratings can be confidential in that either the observer is not identified as the source of the gaming environment information or the player is not identified as having submitted the ratings for the observer.

Also, observers and players can both add ratings about the gaming environment or a gaming establishment, such as the level of service provided, the ambiance, incentives offered, etc. The gaming environment or gaming establishment can be given a rating that is made available to all players. Players may base at least some of the information submitted in their player profiles on one or more ratings.

As discussed above, an observer can be given a particular rating based on player feedback of the gaming environment information submitted to the system by the observer. The system can offer an incentive program to the observer based on favorable ratings. For example, if an observer consistently receives high ratings by players for a period of time, such as a month, the observer could earn a reward. The reward can be any suitable reward including, but not limited to money and prize rewards.

Similarly, players can be offered an incentive for confirming the players visited a particular number of gaming environments or recruited a predetermined number of additional players to join the system. Any suitable incentives for the players can be offered, such as gaming destination opportunities like access to a particular event or complimentary hotel visits and meals. Also, the player incentives can include incentives to access more detailed information about the system. For example, a player who is active might be offered more detailed access to the gaming environment information or might be offered an additional feature available in the player profile, such as player-to-player messages or trip planning.

The ratings can be given in any suitable form, such as a “star” system in which a rating user selects any ratable aspect of the system, such as the gaming establishment or one or more observers, and selects a predefined rating for the chosen ratable aspect. The system can choose to allow any number of aspects to be allowed to be rated, i.e., become “ratable aspects” by any users. For example, the system can offer a five-star rating of the gaming establishment, the gaming environments, and the observers entering information about the gaming environments. The user selects an observer, for example, and assigns a rating of a given number of stars that are based on the quality of the gaming environment information provided by the observer.

The system can also allow a user to enter text feedback in addition to a rating for a particular aspect of the system or might allow the user to endorse any rated aspect of the system. For example, a user could rate an observer with a five-star rating and might additionally endorse the five-star observer by sharing the profile of the five-star observer with other contacts or friends with profiles on the system, by “following” the observer by asking for the rating user profile to be linked to and permitted to access at least some portion of the rated observer profile, and any other way to endorse or otherwise give additional public approval of the rated observer. Any form of endorsing any ratable aspect of the system can be used.

In some examples, players are permitted to access a certain amount of gaming environment information without paying a fee while the disclosed systems might require the players to pay a fee for more detailed access to the gaming environment information and/or additional features provided in the player profile. For example, the system could provide certain information to players free to charge, such as generally identifying the location of various gaming environments and the current status of the gaming environment as being either hot or cold. Sometimes, the free information might be limited geographically or by a capped number of gaming environments identified by the player.

In these example systems in which some information is free and some requires a fee, the systems can provide multiple levels or fee-paying information. A player could pay a fee to have unlimited access to all gaming environment information for a restricted period of time while the player could pay a higher fee for unlimited access to the same information for a longer period of time. The fee could be based on any aspect of the player interactions with the system.

In some examples of the disclosed systems and methods, the players and/or the observers are prompted to input information, such as observer information about a gaming environment, ratings, feedback, responses to incentive offers, and the like. The central server 112 can send any desirable message to the player and prompt the player to input a response at the player device. For example, the central server 112 might send a prompt to a player device after the player confirms visiting a particular gaming environment. The prompt can include a request for feedback on the accuracy of the information relating to the gaming environment (e.g., whether the observer information is accurate), a prompt to share gaming environment information with other players, an invitation to accept an incentive or to join in a contest or program for earning an incentive, and the like.

The prompt can also be in response to a player initiated request to access gaming environment or other system information that requires a fee. The fee prompt might be sent to the player to alert the player that a fee is going to be charged or to seek approval and payment from the player for the additional fee. Any suitable prompt can be sent to the players. Further, the players can receive pushed information without requiring a response, such as advertising, weather information, schedules on upcoming events nearby, special offers.

The gaming environment information the players receive can, in some examples, include geographic information about the gaming environment. For example, the geographic information may be a map of the geographic region surrounding the gaming environment and can also include directions and transportation options for traveling from the player's current location to the gaming environment. The gaming environment might even have a connection to transportation service, like a taxi or van service, that can be scheduled through the system by the player. The gaming environment information can also include information about other gaming environment nearby to the sent gaming environment. For example, the player might want to know about other games nearby and directions on how to travel to the other games.

The system can also include a feature that allows one or more users to “follow” one or more aspects of the system, such as gaming establishments, gaming environments, and observers. Any aspect of the system can be followed. Following one or more aspects of the system includes allowing a user to automatically or on request access, respond to, and/or monitor at least some portion of the profile or publically-available information about the aspect being followed. For example, a player-user might want to follow a particular observer that the player-user likes because of past good input about gaming environments from the observer. The player-user sends a request to the system to link the player-user profile to the observer profile. Once linked, the player-user can view all new gaming environment information input by the observer and any other information, such as when the observer plans to be actively inputting gaming environment information.

The players can also track and monitor the gaming environment information by the observer, whether linked or not. If the player is linked to a desirable observer profile, the player can simply track the gaming environments about which the observer inputs gaming environment information. Alternatively, the player could also view, on request, periodically or regularly, the observer profile to view the gaming environments about which the observer has recently input gaming environment information.

The players can track and monitor gaming environments by any aspect the system allows, such as by the observer, by the gaming establishment, and by the gaming environment itself. The players can track and monitor the gaming environments in any suitable manner and can customize the tracking and monitoring. For example, the player wishes to track and monitor gaming environments at three different gaming environments that the player historically enjoys. The player might also want to track and monitor two observers because the player has historically found the gaming environment information input by the two selected observers is accurate and complete. The system can allow the players to customize and select any aspect of the system to track and monitor.

II. Multiple-User Information Sourcing Methods

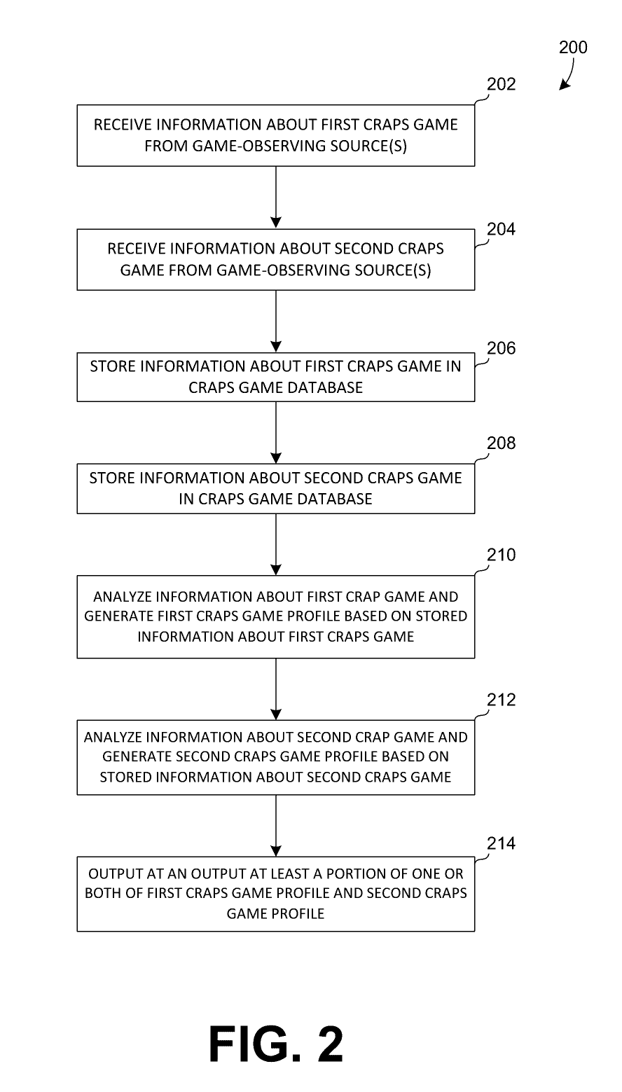

FIG. 2 shows an example method of sourcing multiple-user information 200. Any one or more of the method steps discussed can be implemented on any portion of or all of the system components discussed above in reference to FIG. 1. Some of the method steps can be implemented on a computing device by instructions in the form of any suitable computer-readable medium.

The multiple-user information sourcing methods can include any of the steps shown in FIG. 2, fewer steps, and/or additional steps. Information is received from a game-observing source, like the observers discussed above, about one or more games within one or more respective gaming environments. In the example shown in FIG. 2, the game is a craps game and the game-observing source(s) are observers. As such, information about a first craps game is received from a game-observing source 202. Information about a second craps game is also received from a game-observing source 204. The game-observing source observing the first game and the second game is a different source in this example, however, the same source could observe more than one game in an alternative example.

In another embodiment, the game-observing sources can include sources like cameras, the dealer, gaming establishment staff, or the like. For example, a gaming establishment might want to offer to its guests the ability to track hot craps tables within the gaming establishment so the guests can enjoy other activities while waiting for an attractive or “hot” craps table. The gaming establishment could place cameras on its craps table to observe the activities at the table and either have a human user review the video and make a determination if the craps table is hot or have some automated analysis, like video analysis software, determine whether the craps table is hot based on the video feed. Any suitable source of observed gaming environment information can be used.

The example method shown in FIG. 2 depicts observing two craps tables. However, many examples include multiple gaming environments. Some examples might restrict the gaming environments within a particular gaming establishment or within a restricted minimum bet required for a particular group of game tables. Other examples might restrict the gamin environments to a geographic region, such as a city or a specific area with a particular city.

Referring again to FIG. 2, the information about both of the first craps game and the second craps game can be stored 206, 208. The game information can be stored in any suitable memory, for example. The stored game information is then analyzed and a game profile is created for each game that is observed. In the example method shown in FIG. 2, the information about the first craps game is analyzed and a first craps game profile is generated based on the stored information about the first craps game 210. The information about the second craps game is also analyzed and a second craps game profile is generated based on the stored information about the second craps game 212.

FIG. 2 also shows that any portion or all of the first craps game profile and the second craps game profile can be displayed on a display 214. Displaying the information is optional. In the examples in which any portion of one or more game profiles is sent to a player's device, the profile information is displayed on the display of the player's device or any other output of the player's device. The information can be transmitted to the player device in any suitable form including through an application running on the player device, through electronic mail (e-mail), short messaging service (SMS) messaging, and any other suitable communications means. Alternatively, the profile information could be transmitted in a telephone call to the player device, if the player device has telephone capabilities like a connection to a cellular network or Internet phone. In the example with a telephone call, the profile information and any other information sent to the player is not displayed on the player device, it is rather a recording or live messaging transmitted over the telephone connection.

Other example methods include the manner in which the observer information, player information, and anything else related to the gaming environments is analyzed. Correlations between the received input information about the gaming environments and the players can be done in any desirable manner. The players could be matched with a particular gaming environment or group of gaming environments based on any identified reasons, such as the player identified interest in a particular game, gaming destination, gaming establishment, type of game, period of time during which the player plans to visit a particular geographic region that includes gaming environments, and the like.

Multiple levels of correlation can also be included in the information pushed to the player. For example, the correlations can include both a particular type of game within a gaming destination over a desired period of time, such as a player visiting a gaming destination for a week-long vacation (or any length of time) who is interested in a particular type of craps game. Any number of player correlations and/or gaming correlations can be included in the resulting information sent to the player. The player can select some of the correlations and the systems and methods described above can also select some of the correlations based on various data like player profile data and other information.

III. Examples of an Observer/Player User Interface

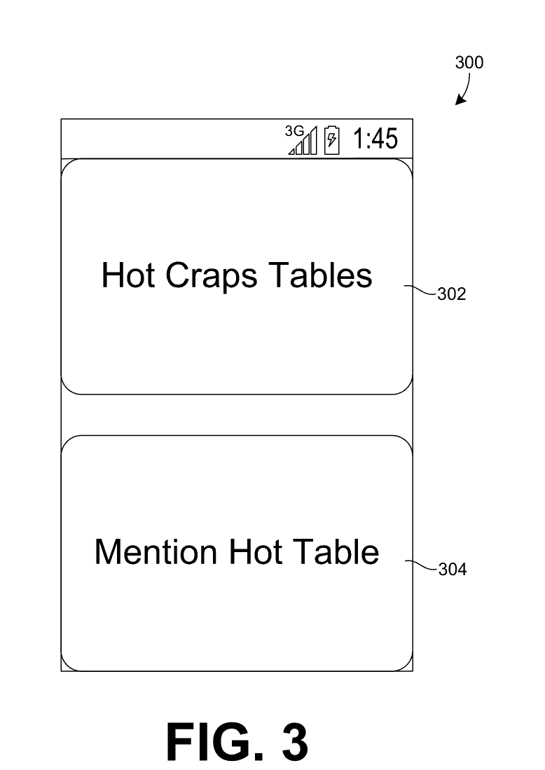

FIGS. 3-10 show example screenshots of a user interface that can be used with the disclosed systems and methods. The user interface shown is for craps games, but the user interface could be customized for other games and gaming environments, as discussed above. The user interface, in this example, is in the form of an application downloaded to a user device. In this example, the application interfaces with the user in roles of both an observer and a player. However, as discussed above, some observers are not players and some players are not observers in alternative examples. Generally, in reference to the user interface screens, the term “user” is used with a descriptor of whether the user is in the observer or the player role.

FIG. 3 shows a screenshot with two options for the user to select 300. The first option is to select/view hot craps tables 302. The second option is to mention a hot table 304. In the first option 302, the user is in the player role and is able to view hot craps tables and other gaming environment information. The viewable hot craps tables can include all hot craps tables or the group could be restricted by geographic region, type of craps game, system and/or player preference, and any other desirable correlation. In the second option 304, mention a hot table, the user is in the observer role and can input observer information about a gaming environment. In this example, the observer is able to select the mention hot table 304 option and can input information about a craps table at which the user-observer is observing gaming environment information.

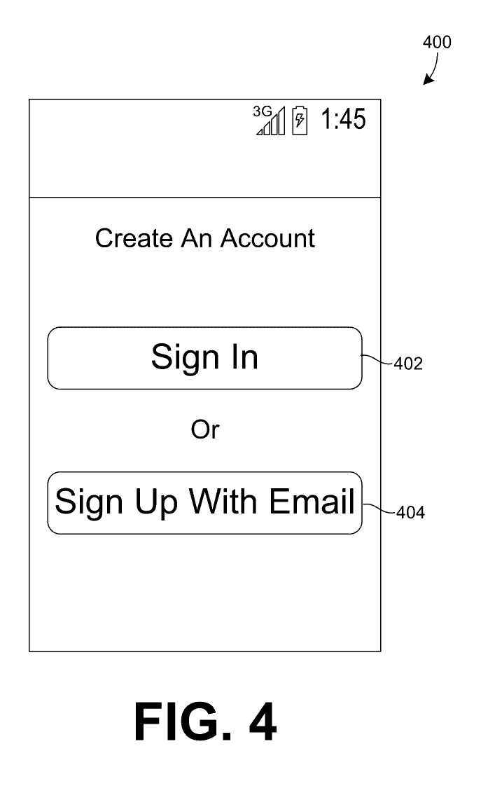

FIG. 4 shows a user sign-in screenshot 400. The sign-in 400 allows a user to create a user profile, such as one or both of an observer profile and/or player profile. A user with an existing profile can select the “sign in” option and a new user can select the “sign up with email” option 404. The new users can sign up with any other identifying information in other examples. The disclosed systems and methods do not require a user to have a profile; however, in this example user interface, the user profile gives the user access to the system features. The user sign in screenshot 400 is shown in this example as being after the screenshot with the options to either select a hot craps table or mention a hot craps table 300. However, in other examples, the users can be prompted to sign in before selecting whether the user would like to select a hot craps table and/or mention a hot craps table. The users can be prompted to sign in at any point during their interactions with the systems and the user interface.

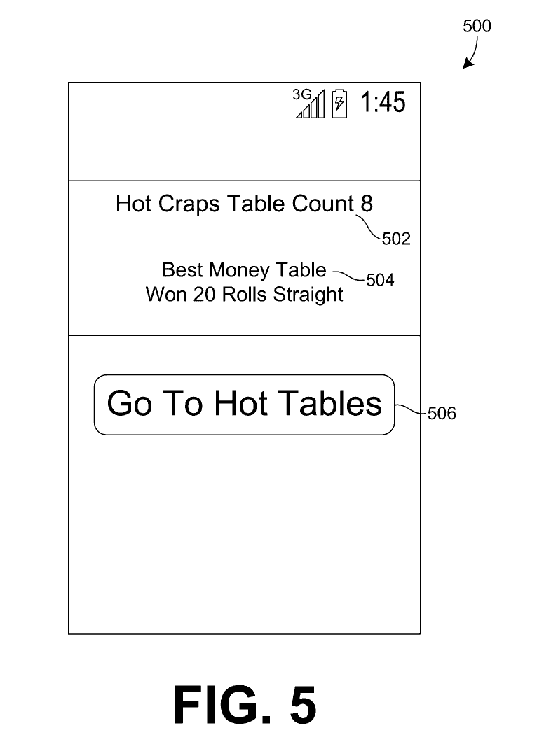

FIG. 5 shows an example screenshot of a user home screen 500. The user home screen 500 can appear after the user signs in with a user profile. The user home screen 500 can be customized to a user profile. The customization can be based on information entered by the user into their profile and/or information the system determines should be customized for the user. In the example user home screen 500 shown in FIG. 5, it shows information about how many craps tables are “hot” 502, the most attractive craps table 504, and a prompt to go to the hot tables 506. The information about how many craps table are hot 502 and the most attractive craps table 504 can both be determined by a predetermined number or qualifications for the craps table being selected for this group. As discussed above, the user and/or the system can determined the group of craps table selected to be in the group viewable by the user based on any user and/or system information.

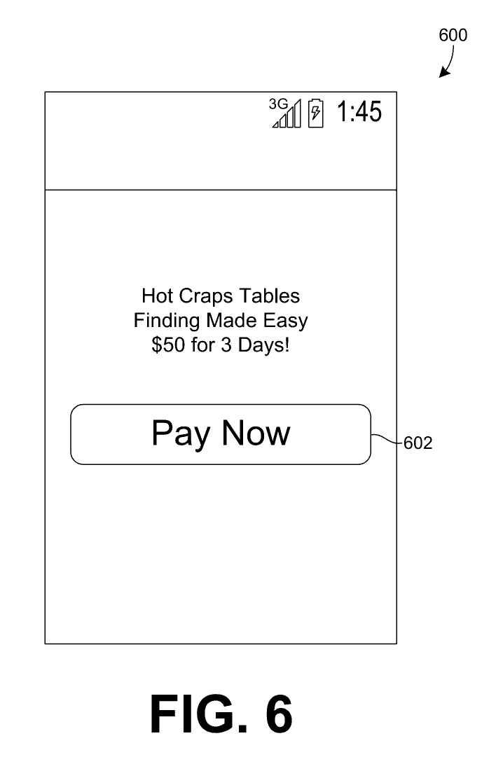

In some example systems, all or a portion of the user information, and more specifically the player information, can be free or alternatively, a fee could be required to access some or all of it. FIG. 6 shows a screenshot of a payment screen 600. In this screen, the user is in the player role since the user is seeking to access information about the gaming environments. The payment screen has a prompt 602 that the user can select to pay for access to the gaming environment information.

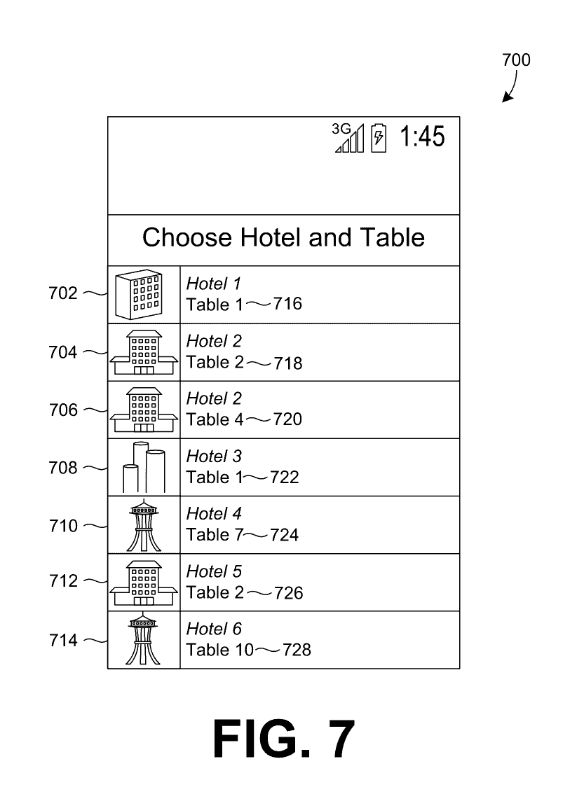

FIG. 7 shows a screenshot of a group of identified hot craps tables 700. Here, the user/player paid the fee on the payment screen 600 shown in FIG. 6 and the identified group of hot craps tables 700 is displayed for the user/player. As discussed above, the list of hot craps tables identified as the group that is then displayed to the user/player can be correlated to the player and/or system preferences. The identified group of hot craps tables 700 includes several gaming establishments located at hotels. Within the hotels, the table number of the hot craps table is also identified so that a user/player can both know exactly which hotel has the hot craps table and which table within a particular hotel is hot. Sometimes, more than one table in a hotel is hot.

In the example group of hot craps tables shown in FIG. 7, six different hotels with game tables 702, 704, 706, 708, 710, 712, 714 are displayed to the user. With each hotel profile is also identified the table at the hotel that is considered to be hot 716, 718, 720, 722, 724, 726, 728. A user/player can select any of the hotel profiles in the identified group for additional information about the hotel and the table and anything else about the identified gaming environment.

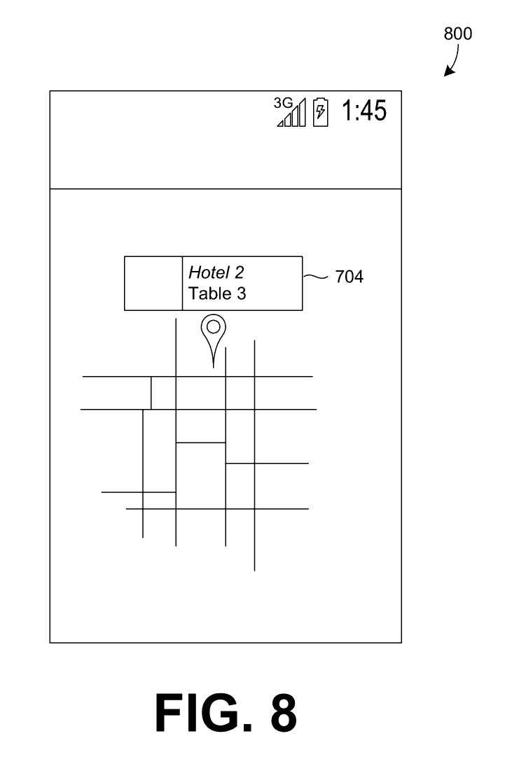

FIG. 8 shows a hotel profile selected by a user/player from the group of identified hotel profiles shown in FIG. 7. In this example, the user/player selected the hotel 2 profile 704. In this example, the hotel 2 profile 704 shows a map of the location for the hotel. Additionally, the hotel 2 profile could give directions to the user from a detected location of the user/player's device on which the user/player is viewing the user interface. Alternatively, the map could show multiple hotel profiles on the same map so a user/player could see the identified hot craps tables' locations relative to each other. Any other gaming environment information can be shown in the hotel profile.

In some examples, the map shown in FIG. 8 can show multiple hot tables. Any number of hot tables can be shown on the map. For instance, the each of hotels 1-6 shown in FIG. 7 can appear on the map shown in FIG. 8. The player user can also select one or more hotels or hot tables elsewhere to display on the map so that the map is customized to the user preferences. Also, the player user can restrict the geographic area of the hot tables shown on the map and can optionally be able to change the geographic area at the user's discretion. For example, the user might want to visit a first geographic area of a gaming destination on a first day and a second geographic area of the same gaming destination on a second day and would customize the hot tables appearing on the map based on the geographic area the player user wishes to visit that particular day.

The disclosed systems can also present to the player users the option to enter a rating or feedback for an observer associated with a hot table directly from the hot table display. For example, the hot tables in the list shown in FIG. 7 and the hot table shown on the map in FIG. 8, or any other display of a hot table can also present to the player user the option to rate the observer directly from the hot table display. The player users can rate the observers or any other aspect of the system in any suitable way and through any prompt or display.

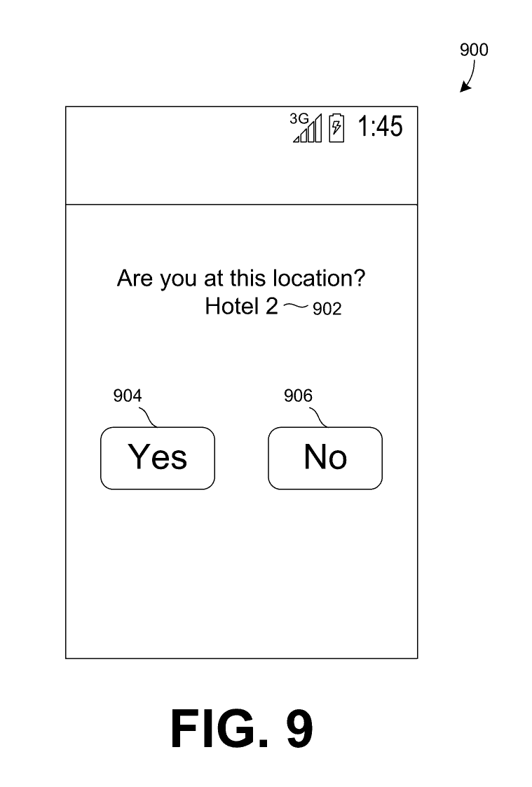

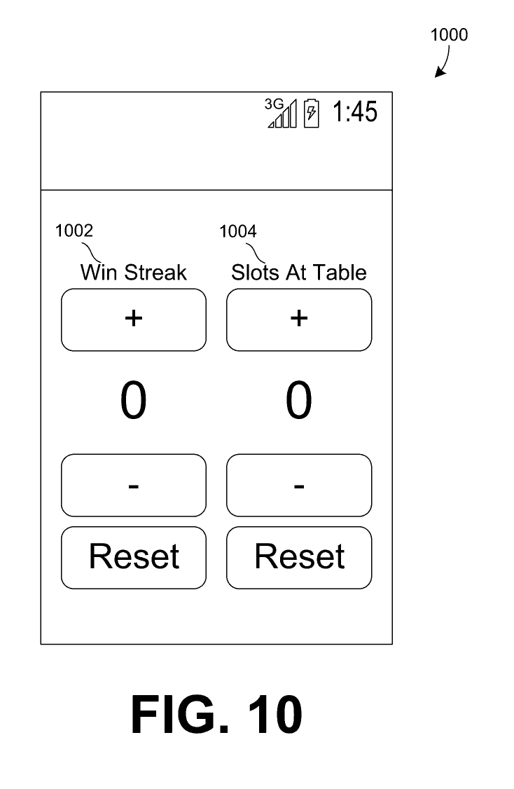

FIGS. 9 and 10 are screenshots that receive gaming environment information from a user in the observer role. Again, as discussed above, the same user can be both an observer and a player. FIG. 9 shows a screenshot of a location confirmation screen 900 that prompts a user/observer to verify the location at which the user/observer is planning to observe a gaming environment. The screen first identifies the gaming environment by the hotel profile name 902, in this example, although the gaming environment could be identified in other ways as well. Then, the screen prompts the user/observer to select either yes 904 or no 906 to verify that the user/observer is located at the identified gaming environment.

FIG. 10 shows a screenshot of prompts for observer information 1000 about the hotel 2 profile that the user verified in FIG. 9. In this example, the user/observer is prompted for information about the winning roll streak for the roller of the selected craps game 1002, in this case, the game at hotel 2, table 3. The user/observer is also prompted to provide information about the number of player slots available at the table 1004. The number of player slots available at the table 1004 reflects the number of additional players that could join the craps game. The example observer information screen in FIG. 10 prompts the user/observer for the win streak and players slots at the table although it could prompt the user/observer for any other information about the gaming environment.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing the invention in diverse forms thereof.

1. A multiple-user information sourcing system for a gaming environment, comprising:
a server configured to:
receive observer information from a first observer device, the observer information including one or more characteristics of a first craps game;
receive observer information from a second observer device, the observer information including one or more characteristics of a second craps game simultaneously occurring with the first craps game and located remote from the first craps game;
store the received observer information including the one or more characteristics of the first craps game in a first craps game profile;
store the received observer information including the one or more characteristics of the second craps game in a second craps game profile;
receive first player information from a first player device, the first player information including one or more characteristics of the first player;
receive second player information from a second player device, the second player information including one or more characteristics of the second player;
automatically correlate the first player information with a first player profile stored on the server and the second player information with a second player profile stored on the server;
a processor configured to
correlate at least a portion of the one or both of the first player profile and the second player profile with at least a portion of one or both of the first craps game profile and the second craps game profile;
before output to any one or more of the first player device and the second player device for presentation to respective one or more players, generate a matched player-craps game option associated with one or both of the first player profile and the second player profile based at least in part on the correlation of one or both of the first player profile and the second player profile with one or both of the first craps game profile and the second craps game profile; and
an output element configured to output, in real time after the matched player-craps game option is generated, at least a portion of one or more of the craps game profile, the player information, and the matched player-craps game option to the one or more of the first player device and the second player device for presentation to the one or more players.

2. The system of claim 1, wherein the processor is further configured to analyze the observer information from the first observer device and the observer information from the second observer device to determine if the one or more characteristics of the first craps game and the second craps game includes information indicating whether the craps game is hot or cold.

3. The system of claim 1, wherein either or both of the one or more characteristics of the first craps game and the second craps game includes at least one of a number of player positions available at either or both of the first craps game and the second craps game and a number of successive winning rolls at either or both of the first craps game and the second craps game.

4. The system of claim 1, wherein the observer information from one or both of the first observer device and the observer information from the second observer device includes at least one of information about another event occurring in close geographic proximity to one or both of the first craps game and the second craps game and information about a gaming environment of one or both of the first craps game and the second craps game.

5. The system of claim 1, wherein one or both of the first player information and the second player information includes player preference data on the type of craps game preferred by one or both of the first player and the second player, and wherein the processor is further configured to analyze the first player information and the second player information to determine if the player preference data on the type of craps game preferred by the first player and the second player correlates with the at least a portion of the first craps game profile and the second craps game profile.

6. The system of claim 1, wherein at least one of the first observer device and the second observer device are the same device as at least one of the first player device and the second player device.

7. The system of claim 1, wherein the one or more of the first player device and the second player device for presentation to the one or more players includes a display, and wherein the display is configured to display a prompt to input additional observer information.

8-22. (canceled)

23. The system of claim 1, wherein one or both of the first observer device and the second observer device, the first player device and the second player device, and the one or more player computing devices are the same device.

24. The system of claim 1, wherein one or both of the first player device and the second player device and one or more player computing devices are the same device.

25. The system of claim 1, wherein the one or more of the first player device and the second player device includes a display configured to display at least a portion of one or more of the first craps game profile and the second craps game profile, the first player information and the second player information, and the matched player-craps game option.

26. The system of claim 1, wherein the processor is further configured to actively transmit, without receiving a request from the first player device or the second player device, a push notification to one or both of the first player device and the second player device, the push notification including one or more of the one or more characteristics of the craps game and a portion of the matched player-craps game option.

27. The system of claim 26, and wherein the processor is further configured to receive an activation notification that one or both of the first player profile and the second player profile are activated, and, in response to the received activation notification, the processor is further configured to determine whether the push notification is relevant to one or both of the first player profile and the second player profile based at least in part on the correlation between the one or both of the first player information and the second player information and the one or both of the first craps game profile and the second craps game profile and, if the push notification is relevant to either or both of the first player profile and the second player profile, the processor is further configured to automatically transmit the push notification to either or both of the first player device and the second player device.

28. The system of claim 1, wherein the received observer information from the one or both of the first observer device and the second observer device includes a status of one or both of the first craps game relative to the second craps game.

29. The system of claim 28, wherein the server is further configured to store in the first craps game profile, the second craps game profile, the one or more of a map of the geographic region surrounding one or both of the first craps game and the second craps game, directions to one or both of the first craps game and the second craps game, and events scheduled to occur nearby to one or both of the first craps game and the second craps game.

30. The system of claim 1, wherein each of the first craps game profile and the second craps game profile is stored in the server in a respective first portion and a respective second portion, the first portion of each of the first craps game profile and the second craps game profile including information about the first craps game and the second craps game that is accessible free of charge to any user of the system and the second portion of the first craps game profile and the second craps game profile including information for which a user is required to pay a fee to access.

31. The system of claim 1, wherein the server is further configured to receive a rating and the processor is further configured to analyze the rating and associate the rating with one of the observer information from the first observer device, the observer information from the second observer device, and the matched player-craps game option.

32. The system of claim 31, wherein the server is further configured to store the first player information in a first player profile and to store the second player information in a second player profile, the server also configured to store the analyzed rating in one or more of the first craps game profile, the second craps game profile, the first player profile, and the second player profile.

33. A multiple-user information sourcing system for a gaming environment, comprising:
a server configured to:
receive observer information from a first observer device, the observer information from the first observer device including one or more characteristics of a first craps game that includes information about the number of available player positions at the first craps game and information on whether the first craps game is considered hot or cold, the information on whether the first craps game is considered hot or cold including both subjective factors and objective factors;
receive observer information from a second observer device, the observer information from the second observer device including one or more characteristics of a second craps game that includes information about the number of available player positions at the second craps game and information on whether the second craps game is considered hot or cold, the information on whether the second craps game is considered hot or cold including both subjective factors and objective factors;
store the received observer information including the one or more characteristics of the first craps game in a first craps game profile;
store the received observer information including the one or more characteristics of the second craps game in a second craps game profile;
receive first player information from a first player device, the first player information including one or more characteristics of the first player, the one or more characteristics of the first player including one or more first player preferences for a desired gaming environment for the first player;
receive second player information from a second player device, the second player information including one or more characteristics of the second player, the one or more characteristics of the second player including one or more second player preferences for a desired gaming environment for the second player;
automatically correlate the first player information with a first player profile stored on the server and the second player information with a second player profile stored on the server;
a processor configured to
correlate at least a portion of the one or both of the first player profile and the second player profile with at least a portion of one or both of the first craps game profile and the second craps game profile;
before sending output to either or both of the first player device and the second player device for representation to respective one or more players, generate a matched player-craps game option associated with one or both of the first player profile and the second player profile based at least in part on the correlation of one or both of the first player profile and the second player profile with one or both of the first craps game profile and the second craps game profile; and
an output element configured to send output to one or both of the first player device and the second player device, each of the first player device and the second player device having a display screen and configured to display on the screen at least a portion of one or more of the first craps game profile, the second craps game profile, the first player information, the second player information, and the matched player-craps game option on the display.

34. The system of claim 7, wherein the one or more player computing devices is at least one of the first player input device and the second player input device.

35. The system of claim 1, wherein the processor is further configured to compare, before sending output to either or both of the first player device and the second player device, the one or more characteristics of the first craps game and the one or more characteristics of the second craps game to generate a craps game comparison based on the comparison, and the output element is further configured to output, in real time after the craps game comparison is generated, at least a portion of the craps game comparison to the one or more player computing devices for presentation to one or more players.

36. The system of claim 1, wherein the server is further configured to automatically transmit a prompt to create a new player profile to a sending player device if no player profile is found to which the first player information or the second player information can be correlated.

37. The system of claim 33, wherein the server is further configured to automatically transmit a prompt to create a new player profile to a sending player device if no player profile is found to which the first player information or the second player information can be correlated.
